(19) United States
(12) Patent Application Publication
(10) Pub. No.: US 2026/0219488 A1
(43) Pub. Date: Jul. 30, 2026

(54) OPTICAL IMAGING APPARATUS

(71) Applicant: Board of Trustees of Michigan State University, East Lansing, MI (US)

(72) Inventor: Elad HAREL, Okemos, MI (US)

(73) Assignee: Board of Trustees of Michigan State University, East Lansing, MI (US)

(21) Appl. No.: 19/137,034

(22) PCT Filed: Dec. 13, 2023
(86) PCT No.: PCT/US2023/083825

§ 371 Date: Jun. 9, 2025

Related U.S. Application Data
(60) Provisional application No. 63/433,104, filed on Dec. 16, 2022.

(51) Int. Cl. G02B 21/36; G01J 3/28; G02B 21/06

(52) U.S. Cl. CPC G02B 21/365; G01J 3/2823; G02B 21/06

(57) ABSTRACT

A method of using an optical imaging apparatus includes emitting light from a laser, tilting a leading phase front of the light relative to a propagation direction thereof, creating a gradient of the light at a specimen to provide a spatial-temporal relationship, rotating at least one of: the specimen or the gradient light part from an initial imaging orientation to a rotated imaging orientation, and reconstructing at least a two dimensional image of the specimen from initial and the rotated orientation images. In another aspect, an optical imaging includes a laser emitting light therefrom, a grating configured to tilt a leading phase front of the light relative to a propagation direction thereof and configured to locally create a gradient of the light at a specimen, a first spatial light modulator configured to shape a portion of the light for an initial imaging orientation, a second spatial light modulator configured to shape a portion of the light for a rotated imaging orientation, an actuator configured to rotate at least one of: the specimen or a gradient light directing optic, from the initial imaging orientation to the rotated imaging orientation, and a spectrometer and programmable controller configured to reconstruct at least a two dimensional image of the specimen from initial and the rotated orientation images.

### CROSS-REFERENCE TO RELATED APPLICATIONS

This application claims the benefit of U.S. Provisional Application No. 63/433,104, filed on Dec. 16, 2022. The entire disclosure of the above application is incorporated herein by reference.

### BACKGROUND AND SUMMARY

The present application relates generally to optical imaging and more particularly to an optical imaging apparatus to measure laser light scattering.

Conventional laser microscopes rely on making a spatial measurement of light, which are diffraction limited. These traditional scanning laser microscopy approaches obtain a spatial image by rastering or scanning across known locations. Traditional magnetic resonance imaging (“MRI”) systems distinguish precession frequencies of nearby spins which are controlled by its magnetic field gradients. An MRI is based on a strong gradient implying a higher spatial resolution, such that multiple dimensions are encoded by phase or frequency encoding. Thus, MRI machines bypass the need for a spatial measurement and are not bound by diffraction limitations.

A known method performs spectroscopic analysis on a sample where wavefronts of some laser pulses are tilted relative to an incident laser pulse. For example, see U.S. Pat. No. 9,001,320 entitled “Real-Time Mapping of Electronic Structure with Single-Shot Two-Dimensional Electronic Spectroscopy” which issued on Apr. 7, 2015, with a common inventor to that of the present application. This patent is incorporated by reference herein. This patent discloses single laser-shot, two-dimensional spectroscopic mapping. While this approach was a significant advance in the field, there is further room for improvement.

In accordance with the present invention, a method of using an optical imaging apparatus includes emitting light from a laser, tilting a leading phase front of the light relative to a propagation direction thereof, creating a gradient of the light at a specimen to provide a spatial-temporal relationship, rotating at least one of: the specimen or the gradient light part from an initial imaging orientation to a rotated imaging orientation, and reconstructing at least a two dimensional image of the specimen from initial and the rotated orientation images. In another aspect, a method and apparatus use gradient reconstruction imaging, with a non-spatial measurement, including emitting a laser pulse through a pulse-front tilt microscope at a specimen, rotating at least one of: a specimen or a gradient light part from an initial orientation to a rotated orientation, then measuring a subsequent laser pulse emission after the rotation, and thereafter, reconstructing a two-or three-dimensional image of the specimen from the initial and the rotated orientation measurements. In an aspect, an optical imaging optionally includes a laser emitting light therefrom, a grating configured to tilt a leading phase front of the light relative to a propagation direction thereof and configured to locally create a gradient of the light at a specimen, a first spatial light modulator configured to shape a portion of the light for an initial imaging orientation, a second spatial light modulator configured to shape a portion of the light for a rotated imaging orientation, an actuator configured to rotate at least one of: the specimen or a gradient light directing optic, from the initial imaging orientation to the rotated imaging orientation, and a spectrometer and programmable controller configured to reconstruct at least a two dimensional image of the specimen from initial and the rotated orientation images. The gradient may be externally or internally generated. A further aspect includes a method and apparatus for obtaining a temporal measurement of a specimen related to space only by a magnitude of a pulse-front tilt, which is found by a calibration measurement.

The present apparatus and method are advantageous over conventional designs. For example, the present method and apparatus use gradient reconstruction imaging, without a spatial measurement and without raster scanning, to remove limits otherwise imposed by traditional optical diffraction. Advantageously, the present method and system obtain a nonspatial measurement of light scattering to recover spatial information not bound by diffraction limits. The present system is well suited for imaging living biological specimens since no light absorption occurs so the specimen is generally unharmed or perturbed by the light. A multi-dimensional and high image resolution of about 5 nm or smaller, may be achieved, in some operating scenarios.

Moreover, the present method and apparatus are advantageous over conventional devices by the use of scattering instead of fluorescence, since scattering scales with the size of the specimen to the power of six, and interference scattering scales with the size of the specimen cubed (in other words, linearly increases with the volume). Taken further, the present scattering events can be measured indefinitely if the light is non-resonant, as compared to fluorescence, in which the observation window is severely limited. Beneficially, the present method and apparatus only need a few dozen projections the reconstruct an entire two-dimensional image of a sample, which may be acquired within about 3 milliseconds. Additional advantages and features of the present apparatus and method can be found in the following description and claims in addition to the appended drawings.

### BRIEF DESCRIPTION OF THE DRAWINGS

FIG. 1 is a diagrammatic view showing the present optical imaging apparatus;

FIG. 2 is another diagrammatic view, perpendicular to that of FIG. 1, showing the present apparatus;

FIG. 3 is a diagrammatic view of a microscope, of the present laser apparatus;

FIG. 4 is a diagrammatic view of a grating generated pulse front tilt, of the present apparatus;

FIG. 5A is a diagrammatic view of an SLM generated pulse front tilt, of the present apparatus;

FIGS. 5B-D are front view light characteristics at the SLM of FIG. 5A, of the present apparatus;

FIG. 6A is a simulated graph showing pulse shaping using a two-dimensional SLM with a phase mask placed in a Fourier plane, of the present apparatus;

FIG. 6B is a simulated graph showing a position versus time profile of a pulse recovered using spectral interferometry, of the present apparatus;

FIG. 7A and B are graphs of spectral interferometry used to measure a time delay between reference and gradient pulses, of the present apparatus;

FIGS. 8 and 9 are diagrammatic views showing gradient and reference pulse scatter from a sample, of the present apparatus;

FIG. 10 is a simulation of GRI showing a diffraction-limited image, of the present apparatus;

FIG. 11 is a graph showing an interferogram pattern associated with FIG. 10, of the present apparatus;

FIG. 12 is an angularly tilted simulation of GRI showing a diffraction-limited image, of the present apparatus;

FIG. 13 is a sinogram associated with FIG. 12, of the present apparatus;

FIG. 14 is a gradient reconstruction associated with FIG. 12, of the present apparatus;

FIG. 15 is an enlarged view of a portion of FIG. 14, of the present apparatus;

FIG. 16 is a diagrammatic view showing gradient imaging along two spatial dimensions, of the present apparatus;

FIG. 17 is a reconstructed specimen image associated with FIG. 19, of present apparatus;

FIG. 18 is a sinogram associated with FIGS. 16 and 17, of the present apparatus;

FIG. 19A and B are diagrams showing a light gradient and pulse delays for a first tilted position, of the present apparatus;

FIG. 20A and B are diagrams showing a light gradient and pluse delays for a second tilted position, of the present apparatus;

FIG. 21 is a top elevational view showing rotation of a sample, of the present apparatus;

FIG. 22 is a perspective view showing a rotary table for the sample of FIG. 21, of the present apparatus;

FIG. 23 is a diagrammatic view showing another embodiment of the present apparatus;

FIG. 24A and B are a graph and diagrammatic view showing another embodiment which generates a gradient by passing light through a mask directly below a sample, of the present apparatus;

FIG. 25 is a diagrammatic side view showing another alternate embodiment including a doped optic with different diffraction indices, of the present apparatus;

FIG. 26 is a perspective view showing an off-axis periscope optionally used to rotate the laser light in any of the embodiments herein; and

FIG. 27 is a diagrammatic view showing an optical configuration generating a local gradient for any of the embodiments herein.

### DETAILED DESCRIPTION

The present optical imaging apparatus generally pertains to ultrafast, coherent, optical spectroscopy where a laser emits light pulses through a high-resolution optical microscope, and a controller reconstructs a two-dimensional or three-dimensional image of a specimen or sample, from initial and rotated measurements. The optical imaging apparatus generates a gradient at the sample which imparts a spatial-temporal relationship, tilts a leading phase front of the light relative to a propagation direction thereof, measures interference signals between a gradient light part and a reference light part with a spectrometer to retrieve a one-dimensional projection of the sample measurement along an initial gradient orientation, rotates at least one of: the sample or the gradient light part from an initial orientation to a rotated orientation, then measures subsequent laser light scattering after the rotation, and reconstructs at least the two-dimensional image of the sample from the initial and the rotated orientation measurements. The present apparatus uses gradient reconstruction imaging (“GRI”), with a non-spatial measurement, including emitting a laser pulse through a pulse-front tilt (“PFT”) microscope at the sample, rotates at least one of: the sample or a gradient light part from an initial orientation to a rotated orientation, then measures a subsequent laser pulse scattering off the specimen after the rotation, and thereafter, reconstructs a two-or three-dimensional image of the sample from the initial and the rotated orientation measurements.

Spatial light modulators (“SLM”) offer phase or amplitude modulations across two dimensions, in one configuration. Alternately, a one dimensional SLM can be used if the SLM generates a grating pattern rather than a gradient mask pattern. In another variation, a physical mask may be used where an amplitude of phase pattern is permanently etched, if the resolution and field-of-view remain constant.

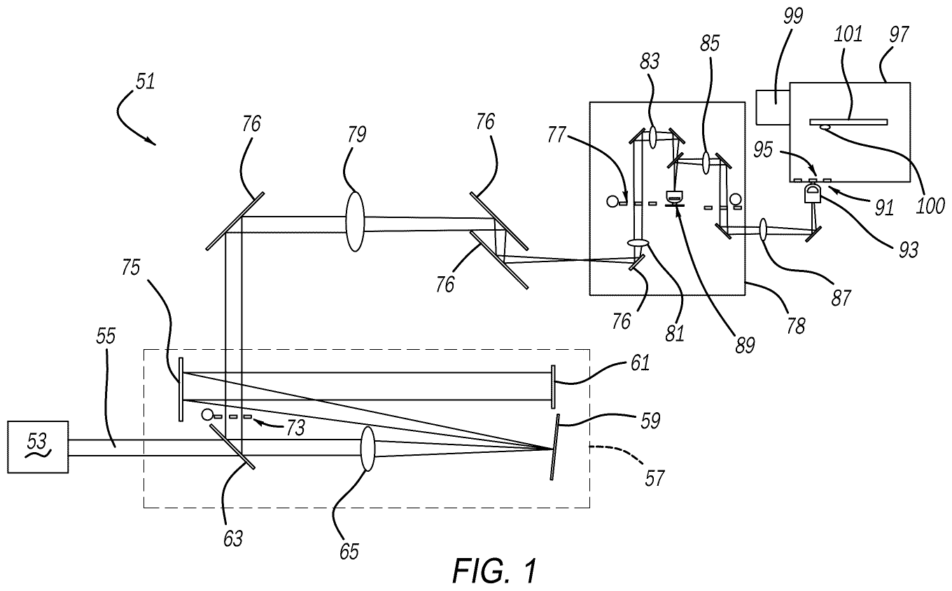

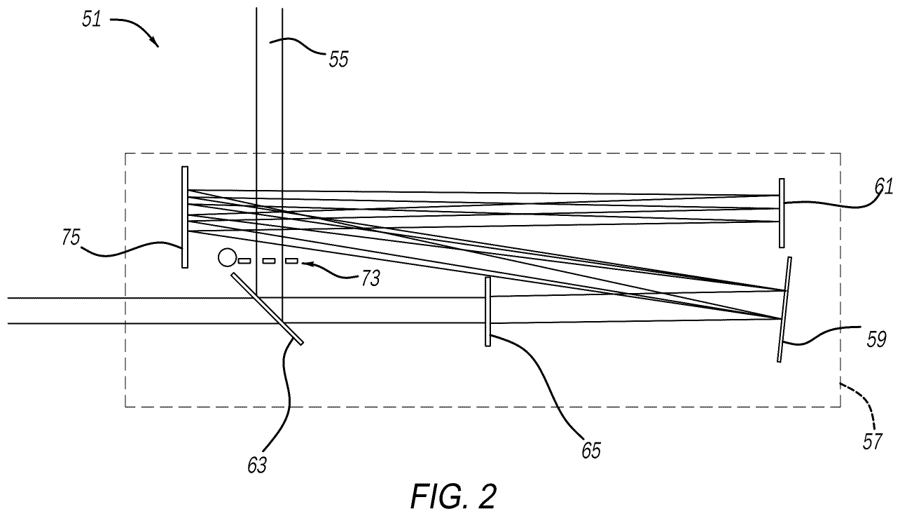

FIG. 1 (horizontal direction as illustrated) and FIG. 2 (vertical direction) show a preferred embodiment of an optical setup employed in an optical imaging apparatus 51. A laser 53 emits a train of pulses 55 to a gradient assembly 57. Gradient assembly 57 includes a 4 f pulse shaper 61 and a phase mask. Each beam pulse 55 passes through a 50/50 beam splitter 63 and a cylindrical lens 65 (having an exemplary f=150 mm) which focuses the light in one direction (vertical, in the illustrated view) onto a grating 59 (preferably 1200 l/mm) configuration of shaper 61. Grating 59 disperses the light in the orthogonal direction (in plane, in the illustrated view), and a spherical mirror 75 focuses each color to a different position on phase mask 61.

Any laser pulse duration can be employed as long as the pulses are spectrally broad. The present system uses a common-path interferometer so that both the gradient and the reference pulses travel through the same optical path. The resolution is therefore set by the transform limit (“TL”) of the pulse. Ideally, a 10 fs or shorter TL duration pulse, from a ti: sapphire oscillator, should provide a good balance between resolution and pulse entered needed to measure the weak scattering signal.

The vertical line on the grating is also relayed to the phase mask, so that each ‘row’ of the light experiences a different wavelength-dependent modulation according to the pattern on the mask. It is noteworthy that mask 61 may operate in either a phase or amplitude mode. The former changes the relative phase between the polarization components of the light, while an amplitude mask imparts an amplitude modulation to the light's spectrum. Both approaches allow each ‘row’ of the light to be composed of two parts: a reference pulse and a time-delayed pulse. In aggregate, the entire light beam composed of all the rows reflected off the mask constitute the “gradient” pulse.

The light pulse 55 is subsequently reflected off mask 61 and retraces a reverse path through shaper 59, but is slightly offset in the vertical direction illustrated in FIG. 2. This allow it to be picked off from the incoming beam. An image focal plane 73 is also present within gradient assembly 57.

Next, the pattern on mask 61 is effectively relayed via mirrors 76 to the focal plane 77 of a microscope 78 through a series of telescoping optics including an exemplary f=250 mm lens 79, exemplary f=100 mm lens 81, exemplary f=250 mm lens 83, exemplary f=180 mm lens 85 and exemplary 125 mm lens 87. By way of nonlimiting example, 250 mm and 100 mm lenses creates a 4~× times smaller beam at the intermediate focal plane 89, while further optics relay the intermediate focal plane to a focal plane 91 of microscope 78. Depending on a focal length (preferably 20× NA 0.2) of an objective microscope lens 93, the pattern on the mask may be reduced by at least 100×.

Thereafter, light pulses are emitted from the microscope objective lens 93, through slits or apertures 95 in an optical Raman spectrometer 97. An array detector, such as a CCD camera 99, is associated with spectrometer 97 to detect and capture images of a specimen or sample 100 on a table 101 therein after the specimen-scattered light is passed through a spectrograph. Spectrometer 97 measures an interaction of the grating-diffracted constituent light wavelengths interacting on the specimen (such as scattering), based on electromagnetic radiation of the specimen in the spectrometer.

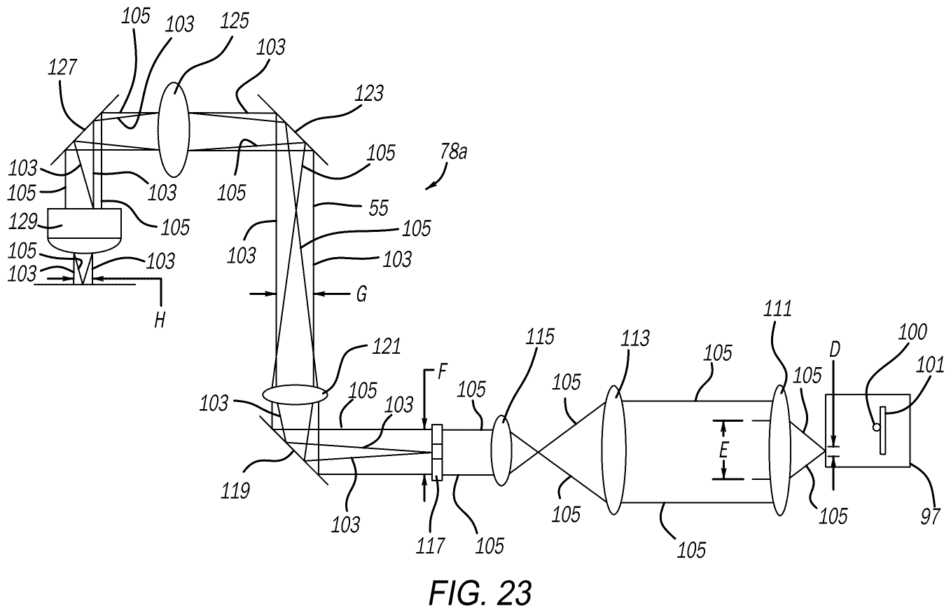

Another embodiment of a spectroscopy microscope 78a can be observed in FIG. 23. In this configuration, after the incident light strikes sample 100 (see lines 103) it is scattered (see lines 105) and is directed to spectrometer 97. Efficient collection of all the scattered light is realized by using the appropriate relay optics to the narrow entry slit of spectrometer 97, such optics including an exemplary 10×, NA=0.25 objective lens 111, a f=200 mm lens 113, a f=30 mm lens 115, a reverse pinhole optic 117, a reflective mirror 119, a f=200 mm lens 121, another mirror 123, a TL f=180 mm lens 125, another mirror 127, and an optic head 129. The slit size ‘D’ is usually about the same as the field-of-view at the sample (for example, 10-30 μm), which provides good throughput and high spectral resolution. Also, by way of nonlimiting example, an entrance pupil dimension of the objective at ‘E’ is 1 cm, a light thickness dimension ‘F’ is 2.5 mm, a light thickness dimension at ‘G’ is 2.25 mm and a thickness dimension at ‘H’ is 50 μm. Note, that all imaging information is lost using this approach since all the light intensity is integrated at the detector. However, the specimen imaging information arises from the spectral interferometry pattern generated after the light is dispersed onto a linear array detector. Alternatively, one can forgo the spectrometer altogether and reconstruct the spectrum by delaying the signal with respect to the local oscillator and Fourier transforming the result using an optical spectrum analyzer or an FTIR.

A calibration procedure will now be discussed. It is a desired component of GRI to accurately measure the gradient strength and direction at the sample position. The calibration procedure is as follows:

First, the gradient is measured after the 4 f shaper by directing the light to an imaging spectrometer with a cylindrical lens at the slit position. The grating should provide sufficient resolution to observe fringes at all spatial locations along the slit direction, in other words, along the gradient direction. Furthermore, the spectrometer is accurately calibrated so that each pixel on the sensor is assigned the correct wavelength. A nonlinear fit of the spectral calibration curve is obtained in order to transform from unequally spaced wavelength units to equally spaced frequency units. After this transformation, the data is Fourier transformed into a time domain to generate a calibration curve of space to time delay (between reference and gradient pulses). From the measured gradient strength, the correct relay optics and field-of-view are chosen to achieve the desired spatial resolution at the sample.

Second, once the gradient strength is estimated using the previous step and the magnification expected from the relay optics, one can measure the true gradient strength and direction using a sample characterized by high-resolution scanning probe microscopy. The sample is prepared using nanolithography tools such as a focused ion beam method or other lithographic methods, with features smaller than those targeted by GRI. For instance, if 10 nm resolution is desired, then features as small as 5 nm should be produced. Alternatively, small nanoparticles with known diameters may be used as calibration standards if they are measured independently by high-resolution scanning electron microscopy. A sufficient quantity of such nanoparticles are employed within the field-of-view to accurately measure the gradient, especially if nonlinearities of the gradient are present due to aberrations in the optics. Since only 1D projections are recovered with GRI, the ground-truth images measured by SEM are numerically projected and compared to the measured projection.

Moreover, a procedure for numerically generating all projections and comparing the measured projection may be implemented to recover the gradient direction with high precision. Different transformations of the linear projections are then made using skewing algorithms (for example, stretching and shrinking, or nonlinear transformation) for high fidelity matches between the measured and ground-truth projections. An alternative calibration procedure involves using a single NP on a high-precision x-y translation stage with sub-nanometer step size. While slower, this method may also be used to measure the gradient at all points within the field-of-view, thereby generating a very accurate map of the time delay versus spatial position. It is noteworthy that if this procedure is used, the microscope employs an active stabilization system to keep the sample locked to a precision higher than the desired resolution.

Third, once the gradient is measured at one direction, it may be measured at all directions by rotating the sample about the center of the field-of-view. FIGS. 21 and 22 show a specimen 100 on a high-speed rotary stage or table 101, driven by an electromagnetic actuator 141. Using NPs as markers may be necessary in this case because the exact axis of rotation may not be known with high accuracy. NPs outside the field-of-view of the GRI trial can be located with sub-nm accuracy using particle tracking. Referring to FIG. 21, the specimen marker locations 100 are readily identified via the true rotation axis 143, which is not coincident with the center of the field-of-view.

Fourth, after all gradient directions are sampled and any corrections are made to align each projection to a common rotation axis, the data is assembled as a sinogram (projection vs. angle). The 2D image may then be recovered using a projection reconstruction algorithm such as filtered back projection or other methods as used in computed tomography and magnetic resonance imaging.

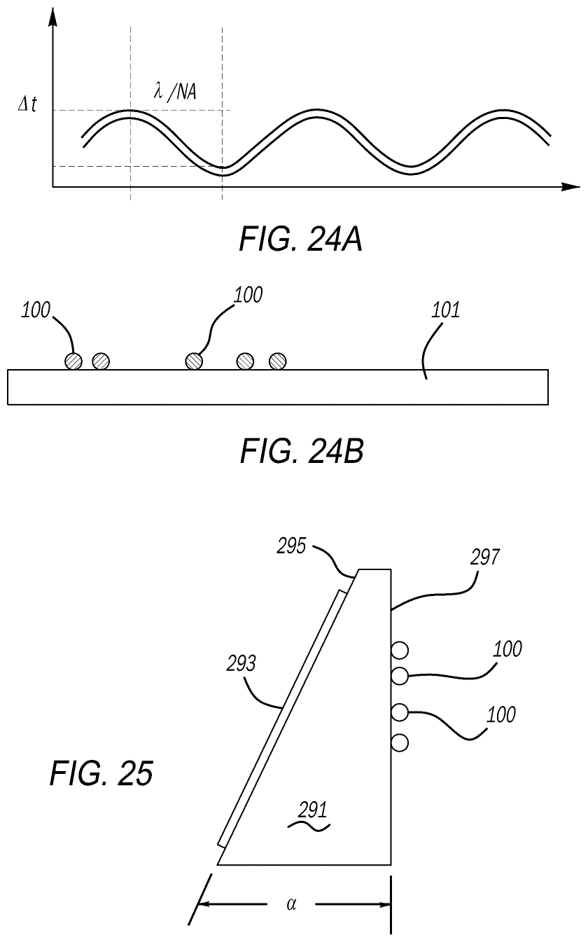

Alternative methods to form gradients are set forth as follows. The gradient as described above may suffer from aberrations and blurring as it propagates through the optical system on its way to the sample. Generating sufficiently high gradients is a challenge due to the extreme magnification needed, while the NA of the optical system may be limiting. An alternative method to generate a gradient is to do so at the sample position directly. For example, a gradient may be generated by passing light through a suitable mask directly below the sample so to create a local gradient. The mask is composed of a pattern of refractive index material such as the sinusoidal pattern shown in FIG. 24A. Instead of generating a large gradient across the entire field-of-view, a local gradient is generated across each pixel, where a pixel is an area limited by the diffraction limit. For instance, the gradient across a pixel may be only a few 100 s of femtoseconds, so that sub-pixel resolution is achieved with short, sub-10 fs pulses. This is in contrast to the afore-described method, where a gradient of 100 s of fs per micron across a field-of-view of 10 s of microns is required to achieve the same resolution. Therefore, unlike with the external gradient case, the gradient at each pixel is measured, but since the pixels are distinguishable by direct imaging, this can be done by using an imaging spectrometer in the detection path. This is illustrated in FIG. 24A and B. A sinusoidal gradient pattern is created in which each pixel (i.e., the resolution set by diffraction) has a gradient imposed on it so the pixel is subdivided according to the ratio of the time resolution and the time delay across the pixel.

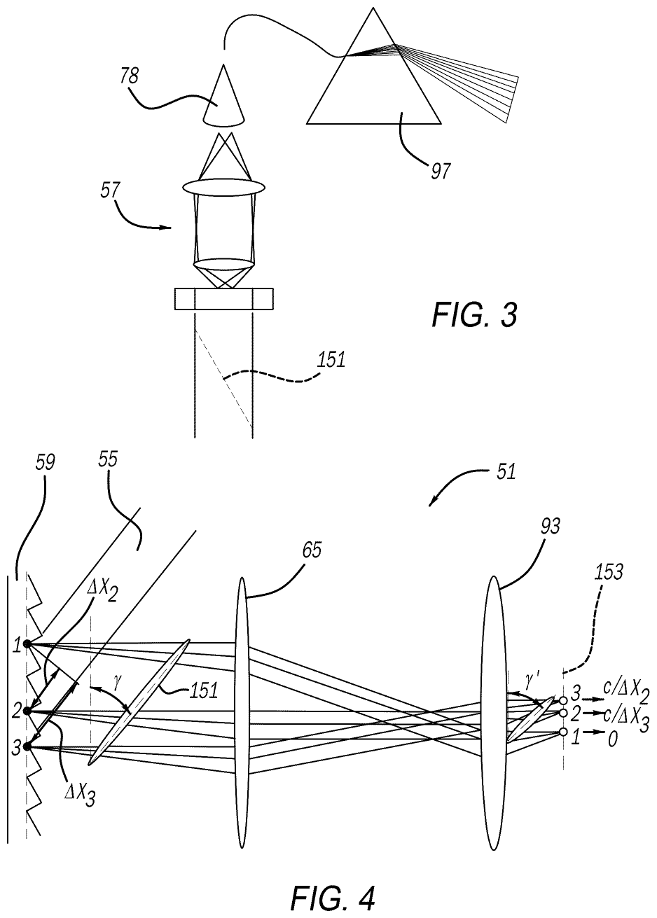

Reference should now be made to FIGS. 3 and 4. The present gradient reconstruction imaging obtains a non-spatial measurement based on differently rotated pulse front tilt 151 positions, which beneficially removes traditional limits imposed by optical diffraction. In principle, GRI can achieve any spatial resolution and because it is based on light scattering, which is non-invasive, it is compatible with living biological specimens. Specimen events may be tracked over long observation periods without risking damage to its living cells, thereby providing access to the molecular choreography thereof at the smallest spatial scales.

The present GRI apparatus and method use an electric-field gradient that exploits a spatio-temporal property of light called a pulse-front tilt 151, which is created by the phase front of pulse light 55. By way of comparison, a nominal and unmodified phase front is parallel to the propagation direction so that in a collimated beam of light, all the photons arrive to the sample at the same time. Optical elements such as mirrors, lenses, etc. can alter this nominal phase front, but typically differences in arrival times of different photons to the target is negligible. In some situations, however, the PFT can be very significant such as when a broadband source interacts with a dispersive element, for instance, a grating or prism. In this case, each spectral component of the light may experience a different amount of dispersion, refraction, and/or diffraction. The modified light pulse may have a severe PFT such that each color of light reaches the sample at appreciably different times-this is sometimes referred to as spatial chirp.

The present system 51 creates and uses a subset of PFT in which all the colors reach the sample simultaneously, but the PFT is now created by an optic in which different spatial parts of the light are delayed with respect to one another. The optic is a spatial light modulator or grating 59, as is shown in FIG. 4. The illustrated grating causes diffracted light at position 1 to arrive before diffracted light at positions 2 and 3, at a specimen image plane 153. The grating strength is determined by the diffraction angle and the beam diameter. In the case of grating 59, PFT 151 is caused by the large diffraction angle; initially the pulse front is orthogonal to the propagation direction, but as the light experiences diffraction, the pulse front is tilted as each spatial component of the light along the grating direction experiences a linear delay with respect to time. The PFT, which can be characterized by the angle gamma, is dependent on the wavelength and the grating period. Notice that while the spectral components of the light are initially separated, they later recombine at the sample position.

The PFT can be increased by demagnification, so that an angle close to 90 degrees is achievable with the appropriate combination of lenses 65. While a grating creates a large PFT, it may not be appropriate for 2D/3D imaging as discussed below. Instead, an SLM may produce the same effect but the magnitude of the PFT is controlled digitally by applying a different amount of phase to each liquid crystal element. This digital control is advantageous for practical realization of Gradient Imaging. Furthermore, FIG. 6B shows the PFT position versus time profile of the pulse recovered by using spectral interferometry.

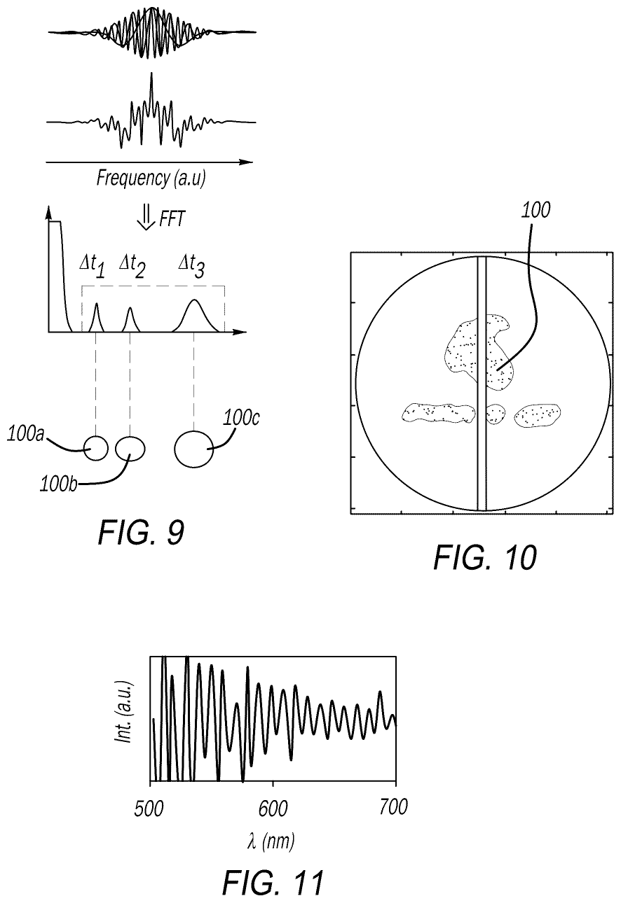

Referring now to FIGS. 8 and 9, a pulse-front tilt microscope of the present apparatus caused the laser beam pulses to each have a severe PFT incident on the sample 100 for an initial step of obtaining one-dimensional image. Therefore, the field arrives at slightly different moments in time along a single axis of the sample and at each location. A pulse front tilt is used to generate a large spatio-temporal gradient and a gradient pulse 157 scatters off the sample and interferences with a reference pulse 161. In GRI, detection is achieved by measuring the time difference of two closely spaced scattering events. More specifically, spectral interferometry measures a temporal delay between two pulses of light to within a small fraction of the pulse duration (based on localization). For example, if two scatterers are spaced apart by 5 nm and the temporal gradient of the light is set to 1 fs/nm, then the interference between the scattered light 159 and a reference pulse 161 will be easily resolvable with a 10 fs reference pulse. Fourier transformation of the signal represents a single projection of the sample along the gradient direction. The uppermost image in FIG. 9 represents spectral interferometry for the 1D image.

It is greatly advantageous that the present apparatus and method do not make a spatial measurement, thereby breaking the diffraction limit. The temporal measurement is related to space only by the magnitude of the PST, which is known by the afore-mentioned separate calibration measurement. To achieve high spatial resolution along a single axis requires a very large PFT, short pulses of light, interferometric detection, and a sufficient number of scattered photons from the nanoscopic object of interest.

Another advantageous feature is that no light absorption occurs so the sample is generally unharmed or perturbed by the light. The use of scattering instead of fluorescence is an important advantage of this approach. Scattering scales with the size of the object to the power of six, while interference scattering (as is done here) scales with the size of the object cubed (i.e. linear with the volume). Moreover, scattering of objects as small as 1 nm (and even from single molecules) can been achieved using interference scattering microscopy (“iSCAT”) and related methods. Again, scattering events can be measured indefinitely by the present system if the light is non-resonant compared to fluorescence, in which the observation window is severely limited.

The present apparatus and method overcome two additional major challenges to achieving gradient imaging: (a) the creation of sufficiently large PFT and (b) 2D and 3D imaging through reconstruction and computational imaging. First, present apparatus and method create a large temporal gradient across the beam profile relative to the duration of the light pulse itself, in other words, the gradient strength. Simple phase tilting, such as that used in conventional spectroscopic applications is limited to only a few hundred femtoseconds per millimeter, while here the requirement is three orders of magnitude larger. The presently preferred use of SLMs provides an advantage regarding image reconstruction in more than one dimension.

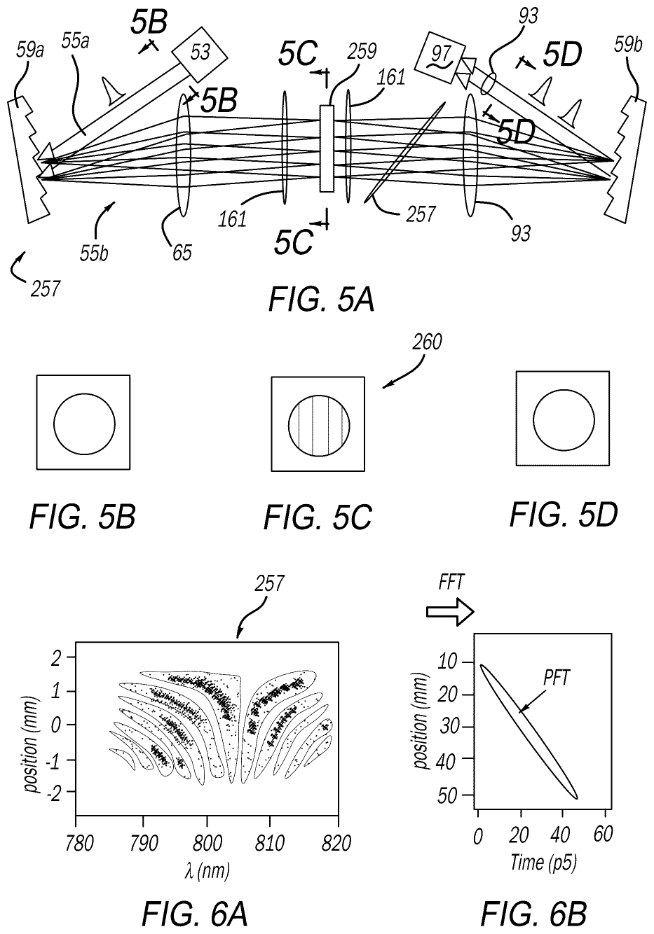

Referring to FIG. 5A, the present SLM-based shaper 257 tilts phase front 257 by controlling a pulse delay at each spatial location of incoming laser pulse light 55a. Furthermore, spatio-temporal gradients can be created by using a high-resolution 2D spatial light modulator 259 which shape different spatial points in the light. More specifically, pulse shaper 257 works by using a first grating 59a to separate the spectral components 55b, which are then focused onto a Fourier plane in the center of the device. A phase mask 260 (see FIG. 5C, with the light color frequencies separated into parallel vertical bands) is programmed onto SLM 259 so that each row has a periodic phase pattern with a different frequency. In the time domain, phase mask 260 creates a pulse pair with a delay dependent on the frequency of the phase pattern. Since the frequency is spatially dependent along the orthogonal axis of the device, the initial pulse is separated into two pulses, one with a flat phase profile (i.e. with the same pulse duration is as the initial pulse) and another with a severe PFT. The second half of the shaper recombines the spectral components, and the light is then directed to microscope 93 and spectrometer 97. In this way, reference pulse 161 is naturally generated by 2D SLM 259. The gradient may then be amplified by optical magnification achievable with a high NA objective of microscope 93. Collimating and focusing lenses 65 and 93, respectively, are also employed in shaper 257.

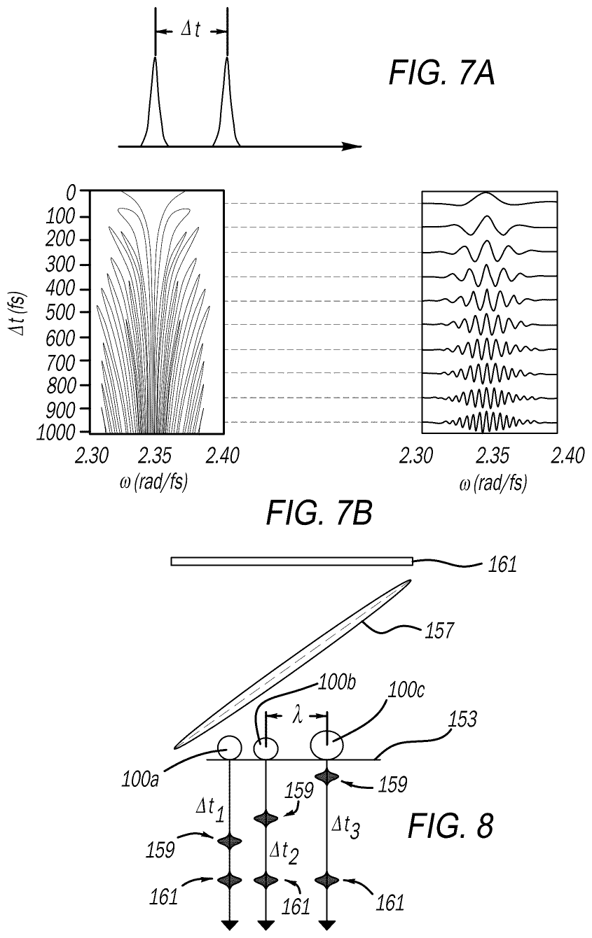

FIG. 6A graphically illustrates position versus wavelength characteristics of an expected pulse front tilt 257 generated by shaper 257. Moreover, FIG. 7A and B represent expected results of spectral interferometry with the present apparatus used to measure the time delay between the reference and gradient pulses.

As shown in FIG. 6A and B, expected results should achieve a gradient of ~1 ps/mm with a high-resolution 2D SLM. Combined with a 100× objective and a 10× relay, this translates to ~1 ps/um. 5 nm resolution should be readily achievable with short pulses on the order of 10 fs. Additionally, higher pixel density SLMs, when combined with improved focusing optics, may increase the gradient strength by an order of magnitude, while laser sources with even shorter pulses (5 fs or less) may be employed.

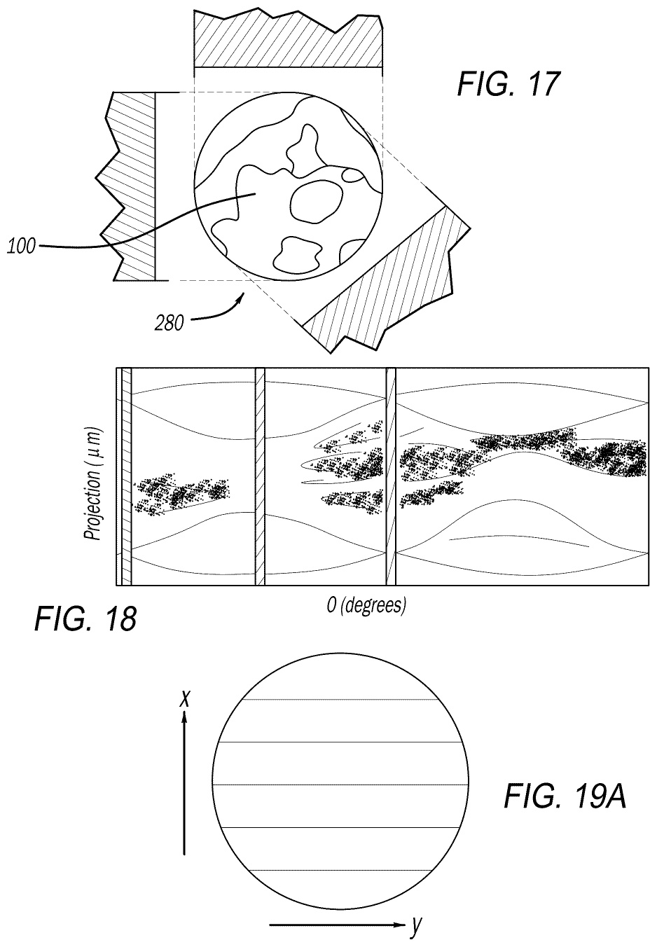

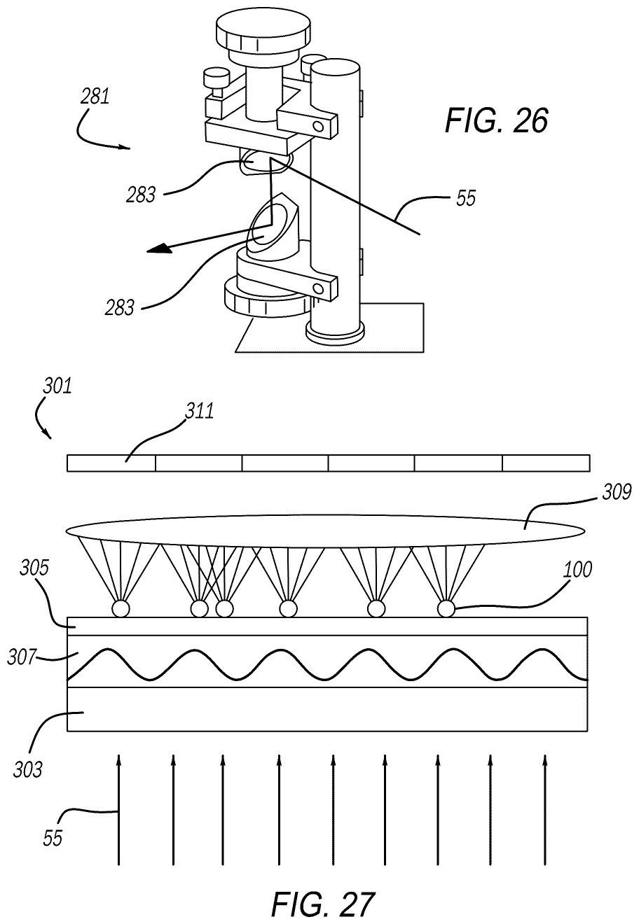

FIGS. 16 and 26 represent gradient imaging along two spatial dimensions where a pair of SLM pulse shapers 259a and 259b encode a gradient along x and y directions, respectively. The gradient may then be generated at any angle in the transverse plane. A series of 1D projections is used to generate a sinogram (FIG. 18) which is then used by a programmable controller to automatically reconstruct a sample image 280 (FIG. 17) by filtered back projection. An off-axis periscope 281, having multiple mirrors 283 therein, is employed to rotate beam 55 approximately 90 degrees, such that the beam oriented along the x direction entering SLM 259a is then rotated by periscope 281 to the y direction prior to entering SLM 259b.

In practice, the resolution is only limited by the achievable signal-to-noise (such as the number of photons scattered from the target and the detection sensitivity) and diffusion of the sample within the time frame of the measurement. The number of photons can be increased in two ways: 1) increasing the power of the excitation source before photodamage occurs, and 2) using shorter wavelength excitation (scattering scales as A-4). However, to avoid any sample absorption, a light source in the visible range is ideal. Diffusion, however, is a more challenging task such that it is desirable to make the full measurement as quickly as possible. Thus, using pulse shapers with high refresh rates (>100 Hz) in the present apparatus should acquire a full 2D image in ~10 ms. In this scenario, the resolution is limited to about 10 nm. Other reconstruction strategies, such as those that utilize compressive sensing or sparse sampling may reduce the acquisition time further. As such, the described implementation of GRI should achieve sub-10 nm lateral resolution for highly dynamic samples, while samples with limited motion (e.g., by tethering) may reach sub-5 nm resolution.

The present apparatus and method advantageously provide 2D and 3D image reconstruction based on GRI. Since the measurement occurs in the time domain (of which there is only one dimension), spatial multiplexing by a camera is not possible. Each experiment records a single projection of the specimen onto the gradient dimension, thereby requiring multiple projections to reconstruct a 2D (or 3D) image. In two dimensions, a pair of SLMs 259a and 259b are be used to generate a gradient in any arbitrary direction by controlling the relative strength of each individual gradient axis. Laser beam light 55 is rotated 90 degrees between the pair of SLMs and the gradient axis is systematically rotated from 0 -180 degrees to form the sinogram of FIG. 18. Programmed software instructions are automatically run by the controller, including a projection reconstruction algorithm, to generate a 2D image. In this scheme there are no moving parts, so the speed of acquisition is limited by the switching rate of the SLMs (about 1 kHz). Typically, only a few dozen projections are needed so that an entire 2D image may be acquired in a few milliseconds.

Alternately, greatly improved acquisition speed may be realized by spinning the sample at thousands of revolutions per second on actuator-driven table 101 (see FIG. 22) while capturing the spectral interferometry data with a high speed linear array detector. In three dimensions, orientation of the sample along all three principal axes may be needed.

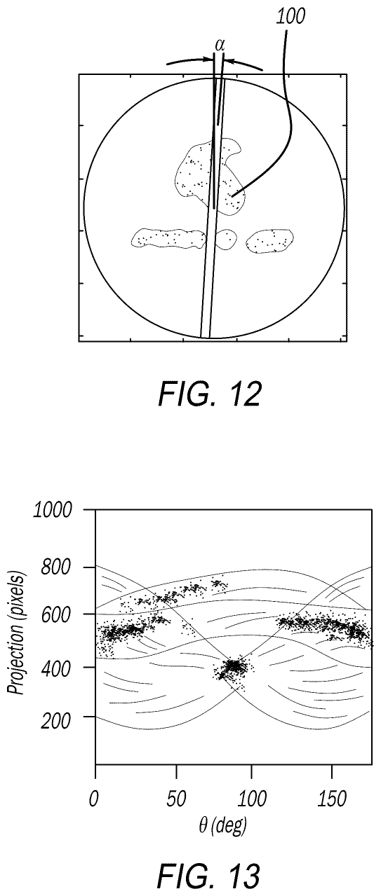

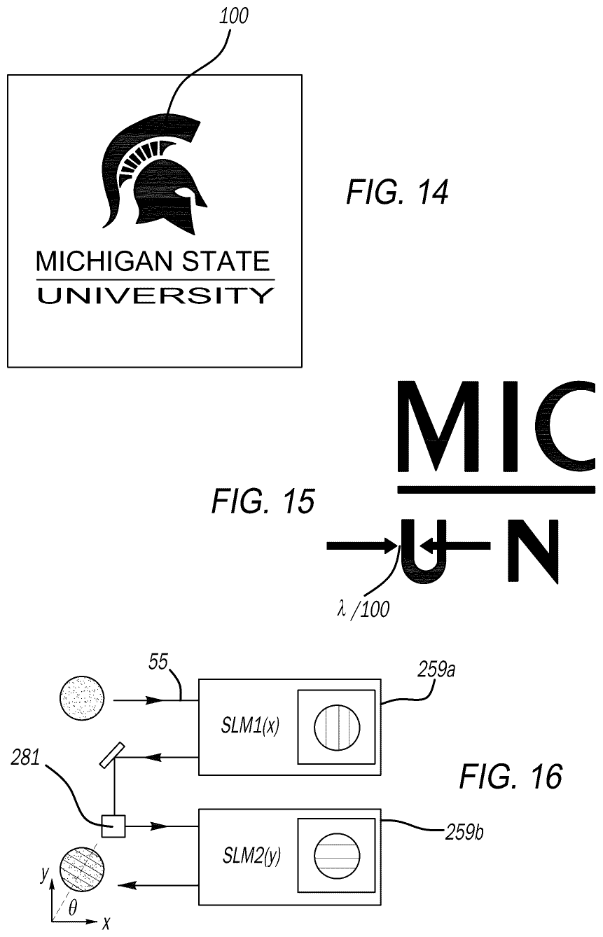

Reference should now be made to FIGS. 10-15. FIG. 10 shows a simulation of GRI with a diffraction-limited image and diffraction-free image in FIG. 14. At each angle (initially at 0° in FIG. 10, next at 0°+α in FIG. 12, and iteratively angularly offset therefrom) a single projection is measured via the gradient being generated using the pair of pulse shapers with orthogonal orientation. The sinogram of FIG. 13 represents the projection versus the angle (0-180 degrees). Thereafter, the interference pattern observed in FIG. 11 is measured using a spectrometer and a Fourier transform is used to generate the sinogram projection in one dimension. Inverse Radon transform is used to recover the 2D image. It is noteworthy that this offset angular rotation of at least one of the specimen or the gradient light, from an initial orientation to a rotated orientation, provides a two dimensional or three dimensional reconstructed image of the specimen without raster scanning.

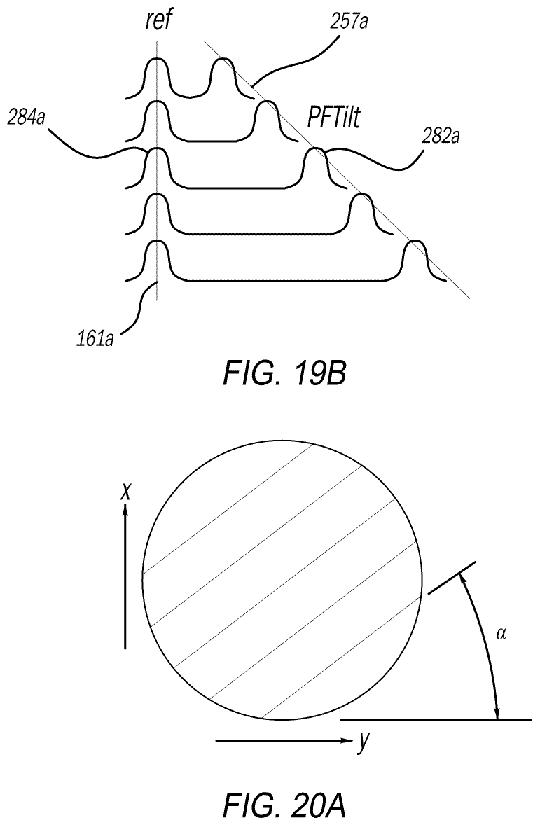

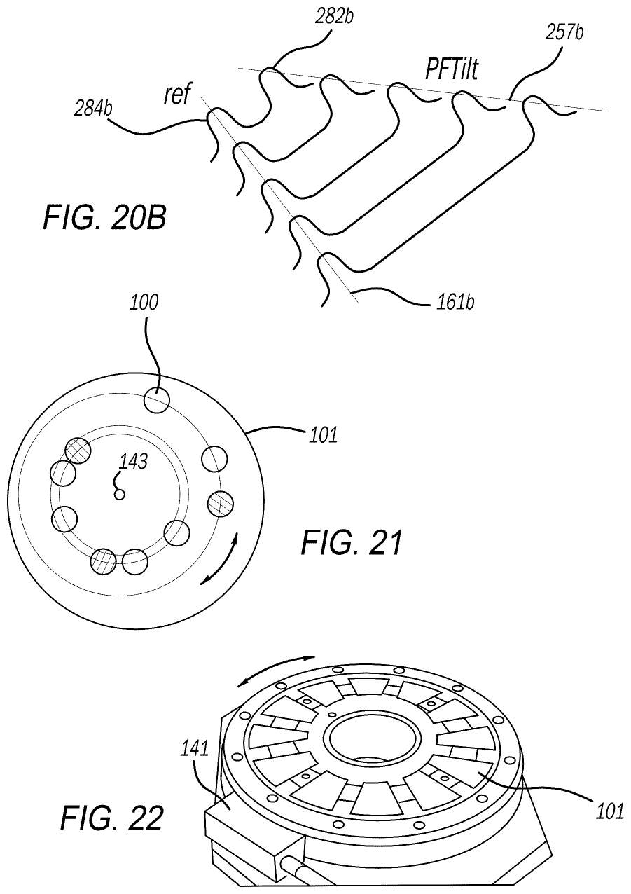

FIG. 19A and B show a first one dimensional x-y gradient of color frequencies, output after first SLM 259a, of a first series of laser pulses in a first angular orientation, with PFT 257a diagonally angled from non-tilted, reference pulse front 161a. A second time-delayed pulse 282a relative to the reference pulse 284a of each series is also represented. FIG. 20A and B then show a different projection, output after second SLM 259b, of a second series of laser pulses in a second offset angular orientation. Offset PFT 257b and reference pulse front 161b, and the associated reference pulse 284b and delayed pulse 282b, are also illustrated.

FIG. 27 illustrates an optical configuration for generating a local gradient, usable with any of the embodiments discussed herein. This local gradient optical system 301 includes a sandwiching glass plates 303 and 305, between which is a refractive index material 307. Incident laser beam light 55 is transmitted to plate 303. Specimens 100 are located on an exit surface of plate 305 and an objective lens 309 receives and focuses the light scattering from the specimens. Downstream, a camera detects the light beam pulses from lens 309, which sends detection signals to the microprocessor for measurements and analysis to reconstruct at least a two dimensional image of the specimen from initial and the rotated orientation images.

An alternate embodiment of a gradient creating optic can be observed in FIG. 25. A glass prism 291 includes light-diffracting ions 293, such as Lithium, doped on a light-entry surface 295, which is diagonally offset angled a from a generally vertically planar light-exit surface 297. Specimens 100 are mounted on exit surface 297.

The present apparatus and method are well suited for use in histology microscopy where tissue structures are examined to identify disease. GRI may readily examine the tissue specimen without the need for staining, by resolving structures at a high resolution. Another end use can be in quality determinations of material specimens for defects in a manufacturing plant. Furthermore, the high resolution achieved by the present GRI system is useful in remoting sensing where a target specimen is spaced away from the apparatus. For example, in airport security detection, facial recognition, weapons detection, autonomous vehicle environmental detection, and the like

While various embodiments have been disclosed, it should be appreciated that additional variations of the present apparatus and method are also envisioned. For example, while exemplary expected results have been disclosed, the actual results may vary. Moreover, additional or different hardware components may be used although certain of the present advantages may not be fully realized. While certain types of optical and laser components have been disclosed it should be appreciated that alternate components may be used although all of the present advantages may not be fully achieved (for example, other gratings, lenses and mirrors). It is also noteworthy that any of the preceding features may be interchanged and intermixed with any of the others. Accordingly, any and/or all of the dependent claims may depend from all of their preceding claims and may be combined together in any combination. Variations are not to be regarded as a departure from the present disclosure, and all such modifications are entitled to be included within the scope and sprit of the present invention.

The invention claimed is:

1. A method of using an optical imaging apparatus, the method comprising:
(a) emitting light from a laser, using scattering of the light without fluorescence and without light absorption on a biological specimen;
(b) tilting a leading phase front of the light relative to a propagation direction thereof;
(c) creating a gradient of the light at the specimen to provide a spatial-temporal relationship;
(d) rotating at least one of: the specimen or the gradient light part, from an initial imaging orientation to a rotated imaging orientation; and
(e) reconstructing at least a two dimensional image of the specimen from initial and the rotated orientation images.

2. The method of claim 1, further comprising measuring interference between the gradient and a reference associated with the light using a spectrometer, to retrieve a one-dimensional projection of a specimen measurement along an initial gradient orientation.

3. The method of claim 1, further comprising using a first spatial light modulator to shape a pulse of the laser light for the initial imaging orientation, and using a second spatial light modulator to shape a pulse of the laser light for the rotated imaging orientation.

4. The method of claim 1, further comprising creating a pulse front tilt using a grating to generate the gradient locally at the specimen using a refractive index, and using a microscope to focus the gradient light into a spectrometer within which is the specimen.

5. The method of claim 1, further comprising creating a two or three dimensional image of the specimen, which includes a biological tissue or cell, with multiple pulses of the laser light, with 5 nm or better resolution and without a spatial measurement and not bound by a diffraction limit.

6. The method of claim 1, further comprising rotating the specimen between the orientations, and using 10 fs or faster duration pulses of the laser light.

7. The method of claim 1, further comprising rotating a direction of the laser light emitted upon the specimen between the orientations, and using 10 fs or faster duration pulses of the laser light.

8. The method of claim 1, further comprising obtaining temporal and not spatial interferometry measurement with a spectrometer to avoid diffraction limitations.

9. The method of claim 1, wherein the rotated imaging orientation is at least 90 degrees offset from the initial imaging orientation.

10. The method of claim 1, further comprising:
a spectrometer using an entire field-of-view signal from the specimen without raster scanning to create at least one of: an interferogram or sinogram, therefrom;
programming a phase mask onto a programmable spatial light modulator; and
tilting a leading phase front of the pulses relative to a propagation direction thereof, the phase mask on the programmable spatial light modulator causing the tilting, and the phase mask creating a pulse pair in a time domain, with a delay dependent on a frequency of a phase pattern.

11. A method of using an optical imaging apparatus, the method comprising:
(a) emitting laser pulses;
(b) focusing the pulses onto a grating;
(c) dispersing the pulses from the grating;
(d) programming a phase mask onto a programmable spatial light modulator;
(e) tilting a leading phase front of the pulses relative to a propagation direction thereof, the phase mask on the programmable spatial light modulator causing the tilting, and the phase mask creating a pulse pair in a time domain, with a delay dependent on a frequency of a phase pattern;
(f) focusing different frequencies of the dispersed pulses onto a specimen to generate a gradient locally at the specimen using a refractive index;
(g) scattering the pulses off of the specimen;
(h) measuring interference signals between the gradient and a reference portion of at least one of the pulses with a spectrometer, to retrieve a one-dimensional projection of the specimen along an initial orientation;
(i) rotating at least one of: (i) the specimen or (ii) the gradient emission direction toward the specimen, from the initial orientation to multiple different rotated orientations; and
(j) automatically reconstructing a two or three dimensional image of the specimen from the initial and the rotated orientation measurements.

12. The method of claim 11, further comprising obtaining temporal and not spatial interferometry measurements with the spectrometer to avoid diffraction limitations.

13. The method of claim 11, further comprising:
causing each of the pulses to have a duration of 10 fs or less;
the spatial light modulator initially separating the pulse into a first sub-pulse with a flat phase profile and a second sub-pulse with the tilt;
the spatial light modulator thereafter recombining the sub-pulses which are then directed to a microscope; and
obtaining a 5 nm or better resolution of the specimen.

14. The method of claim 11, further comprising increasing the tilt by demagnification.

15. The method of claim 11, further comprising automatically causing at least one of the rotated orientations to be at least 90 degrees offset from the initial orientation.

16. The method of claim 11, further comprising using the spatial light modulator to shape at least some of the pulses for the initial orientation, and using a second spatial light modulator to shape at least some of the pulses for the rotated imaging orientation.

17. The method of claim 11, further comprising obtaining the two or three dimensional image of the specimen, which is a living biological specimen, with a 5 nm or better resolution, without a spatial measurement, and using light scattering instead of fluorescence and without light absorption.

18. An optical imaging apparatus comprising:
(a) a laser emitting light therefrom;
(b) a grating configured to tilt a leading phase front of the light relative to a propagation direction thereof and configured to locally create a gradient of the light at a specimen;
(c) a first spatial light modulator configured to shape a portion of the light for an initial imaging orientation;
(d) a second spatial light modulator configured to shape a portion of the light for a rotated imaging orientation, a phase mask programmed onto at least one of the spatial light modulators causing the tilting;
(e) an actuator configured to rotate at least one of: the specimen or a gradient light directing optic, from the initial imaging orientation to the rotated imaging orientation; and
(f) a spectrometer and programmable controller configured to reconstruct at least a two dimensional image of the specimen from initial and the rotated orientation images.

19. The apparatus of claim 18, further comprising a the phase mask creating a pulse pair in a time domain, with a delay dependent on a frequency of a phase pattern.

20. The apparatus of claim 18, wherein:
a duration of pulses of the light is 10 fs or less;
the rotated imaging orientation is at least 90 degrees offset from the initial imaging orientation; and
the spectrometer is configured to use an entire field-of-view signal from the specimen without raster scanning to create at least one of: an interferogram or sinogram, therefrom.

21. The apparatus of claim 18, wherein the light is scattered without using fluorescence, and without light absorption occurring on a living biological specimen.
